(19) United States
(12) Patent Application Publication
(10) Pub. No.: US 2002/0082950 A1
(43) Pub. Date: Jun. 27, 2002

(54) Product planning, development and program management information system and method

(75) Inventors: Jonathan Stuart Anderson, Grand Rapids, MI (US); Simon John Bach, Northville, MI (US); Curtis Albert Bastianelli, Canton, MI (US); Lynn Marie Bosgraaf, Grand Haven, MI (US); Shaun Mark Challoner, Koln (DE); Thomas Joseph Czaplicki, Hudsonville, MI (US); Tamara Ann Essenburgh, West Olive, MI (US); Stephanie Joy Elhart, Holland, MI (US); Lawrence Alan Fieroh, Troy, MI (US); Gerald Keith Ferguson, Clarkston, MI (US); Jonathan Brant Karel, Caledonia, MI (US); James Raymond King, Ann Arbor, MI (US); James Gerald Kremkow, Hudsonville, MI (US); Alok Kumar, Bloomfield Hills, MI (US); Reginald Keith Layton, Kenosha, WI (US); Douglas Norman McLeod, Holland, MI (US); Jeffrey John Reest, Holland, MI (US); Randall Lyle Stroup, Hamilton, MI (US); Michael John Suman, Holland, MI (US); Nancy Ann Vitale, Dearborn, MI (US); John Michael Waraniak, West Bloomfield, MI (US)

Correspondence Address: Alistair K. Chan, Foley & Lardner, Firstar Center, 777 East Wisconsin Avenue, Milwaukee, WI, 53202-5367, US

(73) Assignee: JOHNSON CONTROLS TECHNOLOGY COMPANY

(21) Appl. No.: 09/946,786

(22) Filed: Sep. 5, 2001

Related U.S. Application Data
(60) Provisional application No. 60/230,352, filed on Sep. 6, 2000.

(51) Int. Cl. G06F 17/60

(52) U.S. Cl. 705/27

(57) ABSTRACT

A product planning development and program management information system and method is disclosed. This system is accessible by a plurality of users. The system includes a communications network with a server computer in communication with the communications network and a client computer in communication with the communications network. A first program runs on the server computer. The first program is configured to provide access to a product planning environment through the client computer. The product planning environment has fields for entry of a target price and has fields for displaying a calculated price. The calculated price is based on selections of product characteristics and part selections being made by a user of the first program. The first program provides a display of the product as configured by the user. Further, a second program is in communication with the first program. The second program uses data from the first program and is configured to provide product program management functions.

### REFERENCE TO RELATED APPLICATION

This application claims the benefit of U.S. Provisional Patent Application No. 60/230,352, filed on Sep. 6, 2000, the entirety of which is herein incorporated by reference.

### BACKGROUND

The inventions relate to product planning over a communications network. Further the inventions relate to the management of product development programs over a communications network. Further still the inventions relate to change management and providing prototype exchanges for product development programs over a communications network. Yet further still the inventions relate to providing supplier status information over a communications network. Yet further still, the inventions relate to providing an environment for supply chain management over a communications network.

The internet includes a communications network linking a vast number of computers with smaller computers and computer networks. The computers coupled to these networks exchange information using various services, such as electronic mail, gopher, and the world wide web (WWW). The world wide web allows a computer server (sometimes referred to as a web server or a web site) to send graphical web page information to a remote client computer system. The remote client computer system is configured to display the web page information in a graphical format.

Resources such as individual computers or individual web pages on the world wide web may be uniquely identified by a uniform resource locator (URL). For a user to view a specific web page, a client computer system specifies the URL for that web page in a request, such as a hyper-text transfer protocol (http) request. The request is forwarded through the communications network to the web server that supports the particular web page. The web server responds to the request by sending the particular web page to the requesting client computer system. When the requesting client computer system receives the particular web page, the particular web page is displayed on a video display using a browser. The browser is typically a special-purpose application program that effects the requesting of web pages and the supplying of web pages.

The web pages themselves are typically defined using a hyper-text markup language (HTML) or an extensible markup language (XML). HTML simply provides a standard set of tags that define how a web page is to be displayed. When a user indicates to the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may further contain URLs of other web pages available on that server computer system or other server computer systems, these URLs are often referred to as links. Each of these links may be selected by the HTML document user and an http request is sent to the associated web server.

Although the origins of the world wide web were born from the need for an exchange of scientific and engineering information between scientists and engineers, the world wide web has become specially conducive to conducting electronic commerce (e-commerce) including business-to-business (B2B) commerce. Numerous web servers exist through which vendors and suppliers can advertise and sell products. Products include items that are delivered electronically to the purchaser over the internet (e.g., software and music) and items (e.g., books, toys, and furniture, etc.) that are delivered through conventional distribution channels (e.g., common carriers such as mail delivery and similar services). Web servers may provide electronic catalogs listing items that are available for purchase. These on-line catalogs may be browsed using a browser and various items to be purchased may be selected. In a conventional transaction, a user selects a number of items to be purchased. The server computer system prompts the user for information to complete the order of items. Purchaser-specific information may include the purchaser's name, purchaser's credit card number, and shipping address for the order. The server computer system typically confirms the order by sending a confirming web page to the client computer system and schedules shipment of the items. Further, the server computer system often sends a confirmation e-mail to the purchaser confirming that an order has been sent.

Product planning for automobile, other types of vehicles, and other types of products, especially those products having a large number of parts provided by a plurality of different suppliers or vendors, has been accomplished traditionally without the use of information tools that are at least semi-automated and available to many users over a communications network.

The management of product development programs, for automobile products and other types of products, have been traditionally accomplished without the use of information tools that are accessible by many users over a communications network.

In product development environments, suppliers of services and products have traditionally been linked without the use of information exchanges available to a plurality of suppliers over a communications network.

The status of suppliers of services and products regarding their performance ratings, their participation on specific projects, and their progress in meeting certain goals and/or requirements for awards have been traditionally accomplished without the use of information tools that are accessible over a communications network.

Communication networks enable a large number of users of certain applications to gain access to information from a variety of locations. Accordingly, there is a need for a product planning application that allows for product planning over a communication network. Also, there is a need for a product development management tool that allows the management of product development programs over a communication network and allows product development participants to access information relative to the product development program. Further, there is a need for an exchange for providing services and supplies of products necessary in a product development program. Yet further still, there is a need for an on-line environment such that suppliers of services and products to manufacturers may review their performance ratings, their participation on specific projects, and their progress in meeting certain goals and/or requirements.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the above-mentioned needs.

### SUMMARY

An exemplary embodiment relates to a product planning system accessible by a plurality of users, comprising a communications network, a server computer in communication with the communications network, and a client computer in communication with the communications network. The system also includes a first program running on the server computer, the first program configured to provide access to a product planning environment through the client computer, the product planning environment having fields for entry of a target price and having fields for displaying a calculated price, the calculated price being based on selections of product characteristics and part selections being made by a user of the first program. The first program further provides a display of the product as configured by the user. Further, the system includes a second program in communication with the first program, the second program using data from the first program and configured to provide product program management functions.

Another exemplary embodiment relates to an automotive interior product planning system accessible by a plurality of users. The system includes a communications network, a server computer in communication with the communications network, and a client computer in communication with the communications network. The system also includes a first program running on the server computer. The first program is configured to provide access to an automotive interior product planning environment through the client computer. The automotive interior product planning environment having fields for entry of a target price and having fields for displaying a calculated price. The calculated price is based on selections of product characteristics and part selections being made by a user of the first program. The first program further provides a display of the product as configured by the user. Further, the system includes a second program in communication with the first program, the second program using data from the first program and configured to provide product program management functions.

Yet another exemplary embodiment includes a method of planning an automotive interior product. The method includes receiving from a user of a client computer a product characteristic input, providing to the client computer data that may be used to configure a display of the product including the product characteristic input, and providing to the client computer price information relating to the product characteristic. The method also includes calculating a total price including a price related to the product characteristic, and providing access to a product program management tool.

Yet still another exemplary embodiment relates to a product development system. The system includes a communications network, a server computer coupled to the communications network, and a client computer coupled to the communications network. The system also includes a program running on the server computer, the program configured with a product planning tool, and a program management tool.

Alternative exemplary embodiments relate to other features and combination of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a generalized depiction of a communications network;

FIG. 2 is a depiction of an on-line product planning user interface;

FIG. 3 is a depiction of an on-line product planning interface showing an overhead system;

FIG. 4 is a vehicle summary for an on-line product planning system;

FIG. 5 is a depiction of a user interface for a program management system;

FIG. 6 is a depiction of a user interface for a rapid prototyping and production tooling exchange;

FIG. 6A is a depiction of a part posted for bidding on a rapid prototyping and production tooling exchange interface;

FIG. 6B is a depiction of links for vendor qualification;

FIG. 6C is a tooling schedule for the rapid prototyping and production tooling exchange;

FIGS. 6D-6J are input screens for vendor qualification;

FIG. 6K is an introductory screen for the rapid prototyping and production tooling exchange;

FIG. 6L is a bid administration screen for the rapid prototyping and production tooling exchange;

FIG. 7 is a depiction of a user interface for a supplier status application

FIG. 7A is a tree diagram interface for an advance quality planning program of the supplier status application; and

FIG. 7B is a depiction of a program status matrix for the supplier status application.

### DETAILED DESCRIPTION OF EXEMPLARY EMBODIMENTS

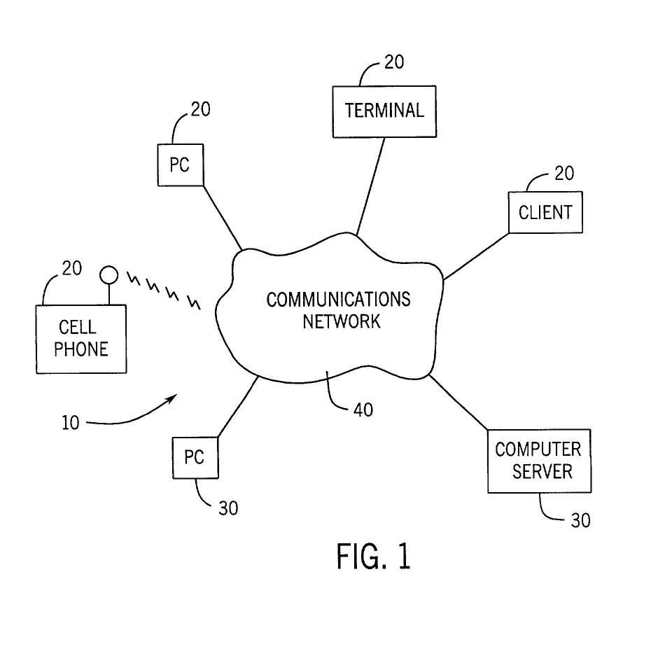

Referring to FIG. 1, in an exemplary embodiment an information system 10 includes a plurality of clients 20 and servers 30 in communication with a communications network 40. Communications network 40 may be, in an exemplary embodiment, any of a variety of communications networks including local networks such as, but not limited to token ring networks, Ethernet networks, intranetworks, and non-local networks, such as, but not limited to the internet, telephone networks, cable networks, satellite networks and other wireless, wired, and/or hybrid networks. Clients 20 may include but are not limited to a variety of information interface devices, including but not limited to computer terminal devices, personal computers, other microprocessor based devices, such as but not limited to personal data assistants (PDAs), cellular telephones, pagers, telephones, televisions, and the like. In an exemplary embodiment servers 30 may include a variety of microprocessor devices, including but not limited to personal computers, mainframe and supercomputers, computer servers, and other types of microprocessor devices capable of storing information and being programmed to run a plurality of programmed steps and/or routines. The user interfaces, programs, applications, and information resources, hereinafter described, may all be made available over a communications network, such as, but not limited to communications network 40. Programs, websites, applications, information services, may be hosted on servers, such as servers 30 and accessed by clients, such as clients 20.

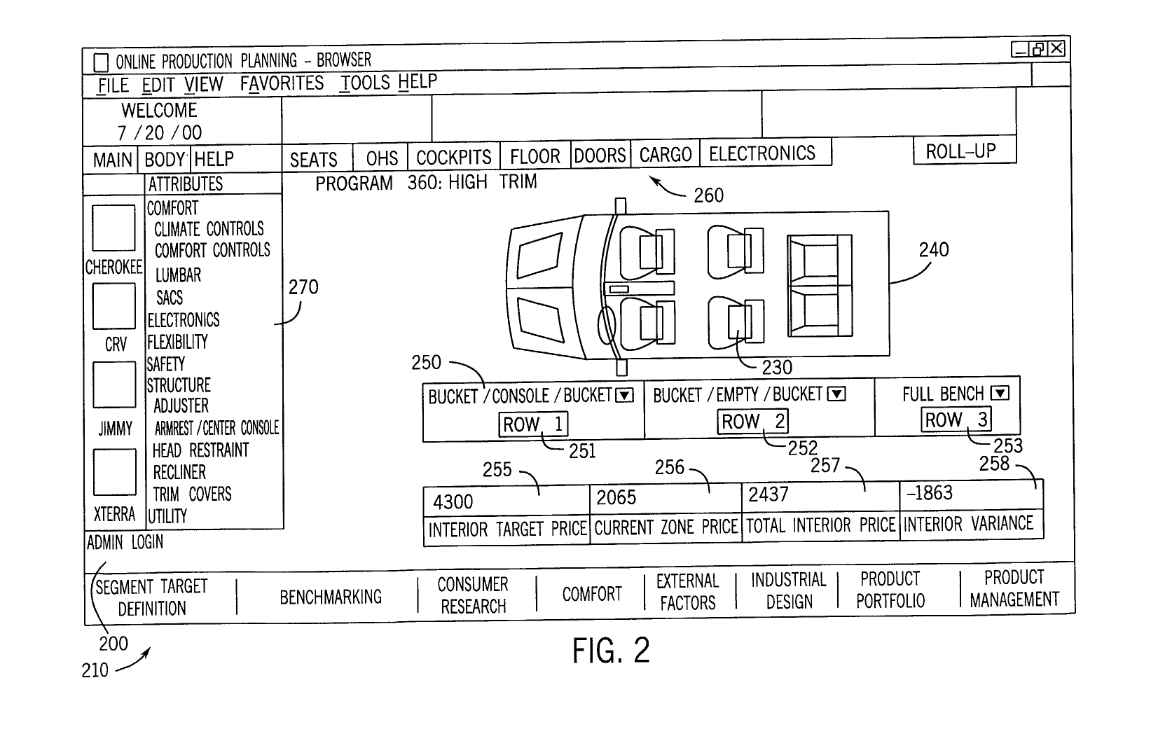

Referring now to FIG. 2, in an exemplary embodiment a user interface 200 is depicted for an on-line product planning system 210. On-line product planning system 210 may be just one part of a total product development tool 220, or product planning system 210 may be a stand alone product development tool. For example, as depicted in FIG. 8, total product development tool 220 may include a plurality of access environments for different types of users. For example, product development tool 220 may include a customer portal 805, a supplier portal 815, an employee portal 820, etc. Further, product development tool 220 may include a plurality of planning, development and management tools, such as but not limited to on-line product planning tool 210, program management tool 510, change management tool 610, supplier status tool 710 and supply chain management tool 810, among other possible tools.

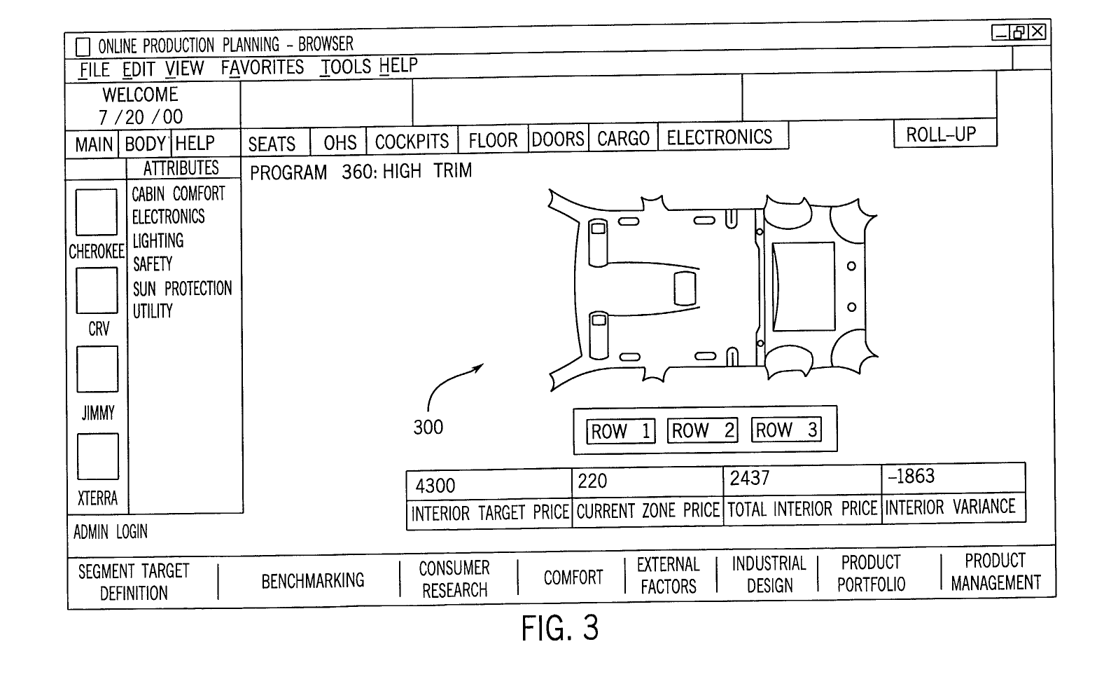

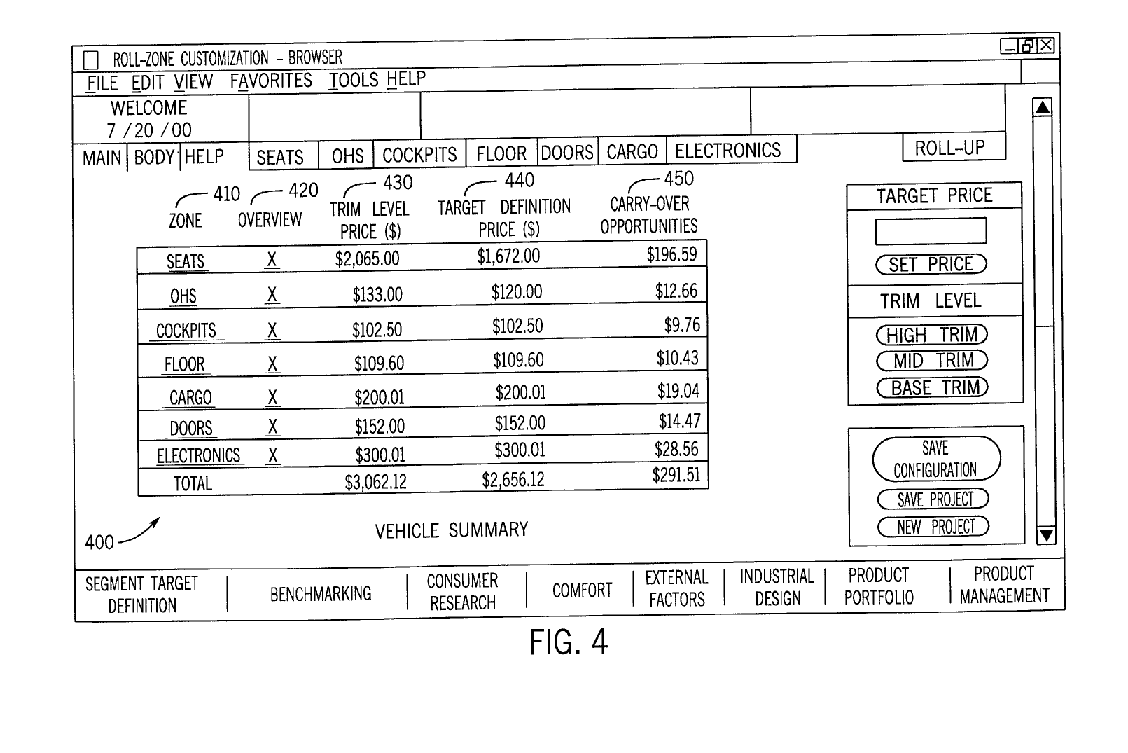

In operation, on-line product planning system 210 may be accessible over a communications network, such as but not limited to communications network 40 (FIG. 1). On-line product planning system 210 may be used for planning a plurality of products, including, but not limited to automobiles. As depicted, on-line planning system 210 is depicted being used to plan a seating environment 230 within an automotive vehicle 240. Interface 210 includes a plurality of input devices such as pull down menus 250 utilized for planning a seating environment 230. As depicted, seating may be selected for a first row 251, a second row 252, and a third seating row 253. For each seating selection a plurality of characteristic price and cost results may be displayed. For example, as depicted, an interior target price may be entered and/or displayed in a field 255. A zone price may be displayed in a field 256, an interior price may be calculated and displayed in a field 257, and an interior variance amount may be calculated and displayed in a field 258. Also, a plurality of other interior features may be selected utilizing a set of links 270. Further, as depicted, a variety of other portions of vehicle 240 may be planned by utilizing buttons 260. On-line planning system 210 allows product planning in an on-line environment such that a plurality of users may gain access to the planning process from a variety of locations. The use of on-line planning system 210 allows input from and early decision making and input from vehicle line executives or other executives and managers thereby providing significant reductions in quote preparation time and costs. Further, on-line planning system 210 allows different users at different locations to make selections of different vehicle environments, such as the overhead systems 300, as depicted in FIG. 3. Overhead system 300 may be selected, and priced similar to the seating environment of FIG. 2. At any point in the design, executives or other users may have access to product reports such as a vehicle summary, as depicted in FIG. 4. Vehicle summary 400 may include, but is not limited to, a column for zones of the vehicle 410, a column for overview links 420, a trim level price column 430, a target definition price column 440, and a carry-over opportunities column 450. Any of a variety of other types of summary data may be provided on screen 400.

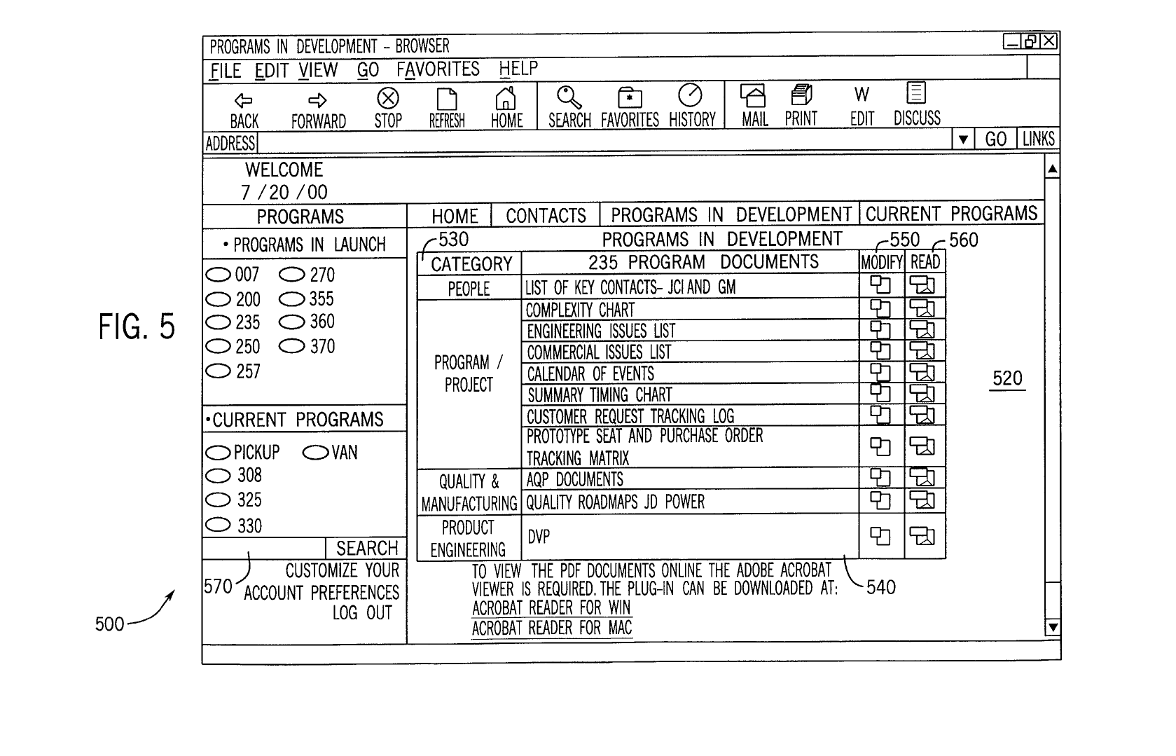

Referring now to FIG. 5, in an exemplary embodiment, a user interface 500 is depicted for an on-line program management system 510. On-line program management system 510 may be just one part of a total product development tool 220, or program management system 510 may be a stand alone program management tool. In operation, on-line program management system 210 may be accessible over a communications network, such as communications network 40 (FIG. 1). On-line program management system 510 may be used for management of programs for product development, including but not limited to the development of automobiles. Program management system 510 provides access to program information to a plurality of users and provides a centralized location where users who may have different roles in a product development project, may obtain access to information if a program manager is unavailable. Project management system 510 may also provide information regarding contacts of those involved in the program, and the like. For example, on-line program management system 510 acts as an internet or intranet portal to provide real time decision making and collaboration on product design, launch, and production readiness. Project management system 510 includes interface 520 having a table relating to a specified program. The table includes a column 530 including different categories of information, a column 540 lists program documents, a column 550 has links to applications for modifying the program documents, and a column 560 has links to documents for reading and review. Certain authorized users may have to log into and have access to modify documents in column 550. Other users may be authorized to only read documents listed in column 560. Users who are authorized to read documents 560 may select each document using a universal reader such as, but not limited to, an acrobat reader, which is capable of viewing documents in the “.pdf” format, however, any document format may be utilized. On-line program management system 510 allows users to connect to data at any time of the day, 24 hours a day, 7 days a week when key personnel, who are traditionally privy to such information, are unavailable. Further, on-line program management system 510 may include a search engine 570 which may be used to conduct keyword searches throughout the list of documents. Accordingly, users in search of specific information relating to a program in development may use search engine 570 to quickly locate and view relevant information. On-line program management system 510 allows for real-time decision making and collaboration on product design, launch, and production readiness in a rapid manner while providing access to users in non-centralized locations.

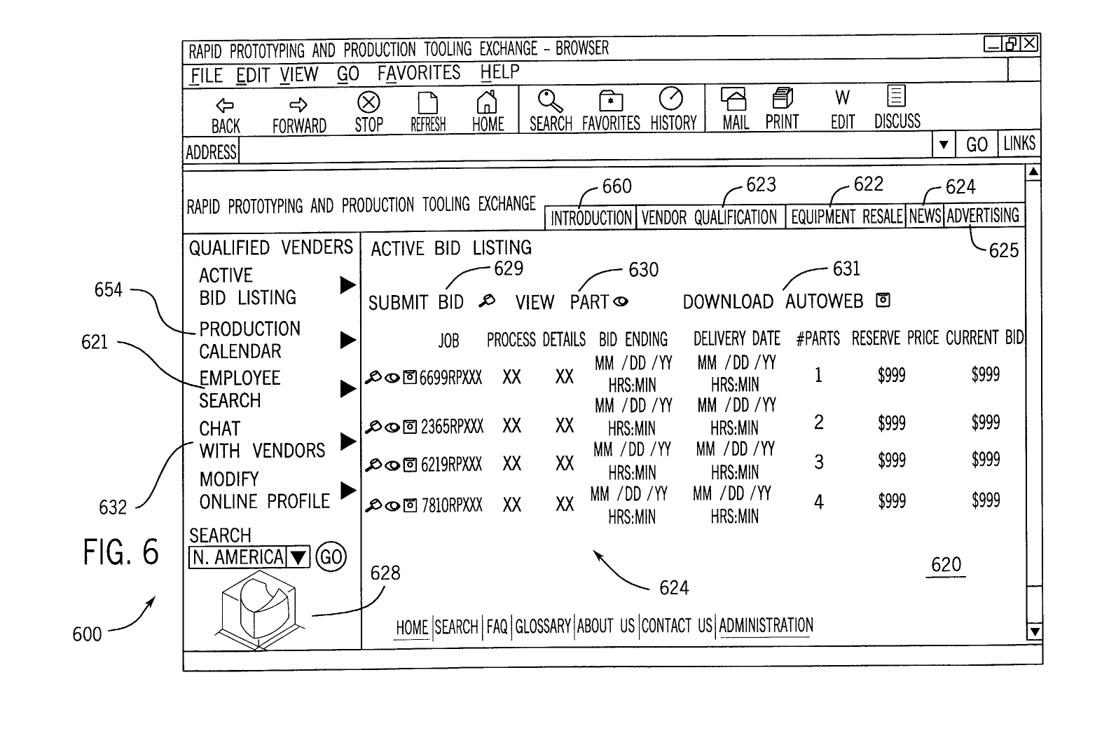

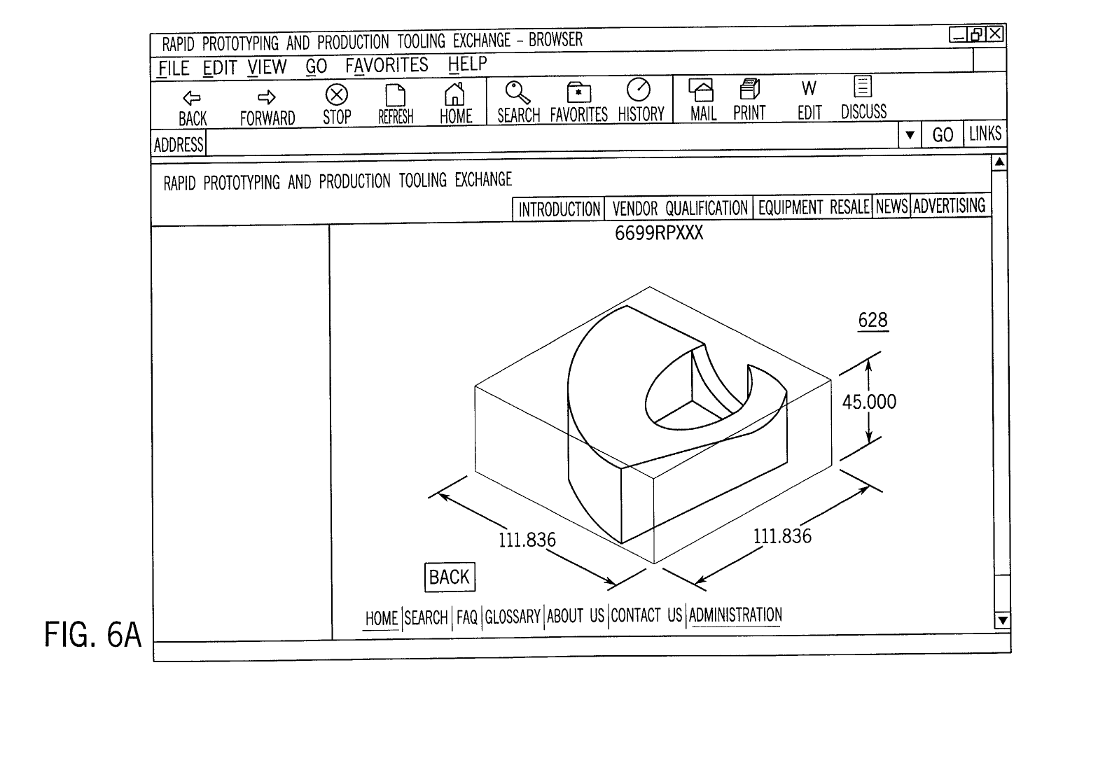

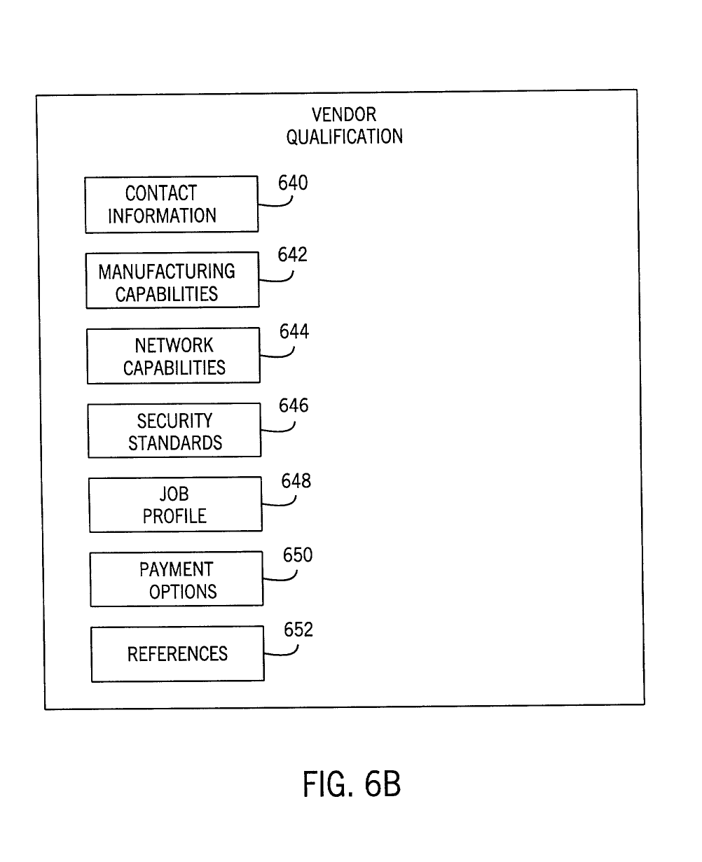

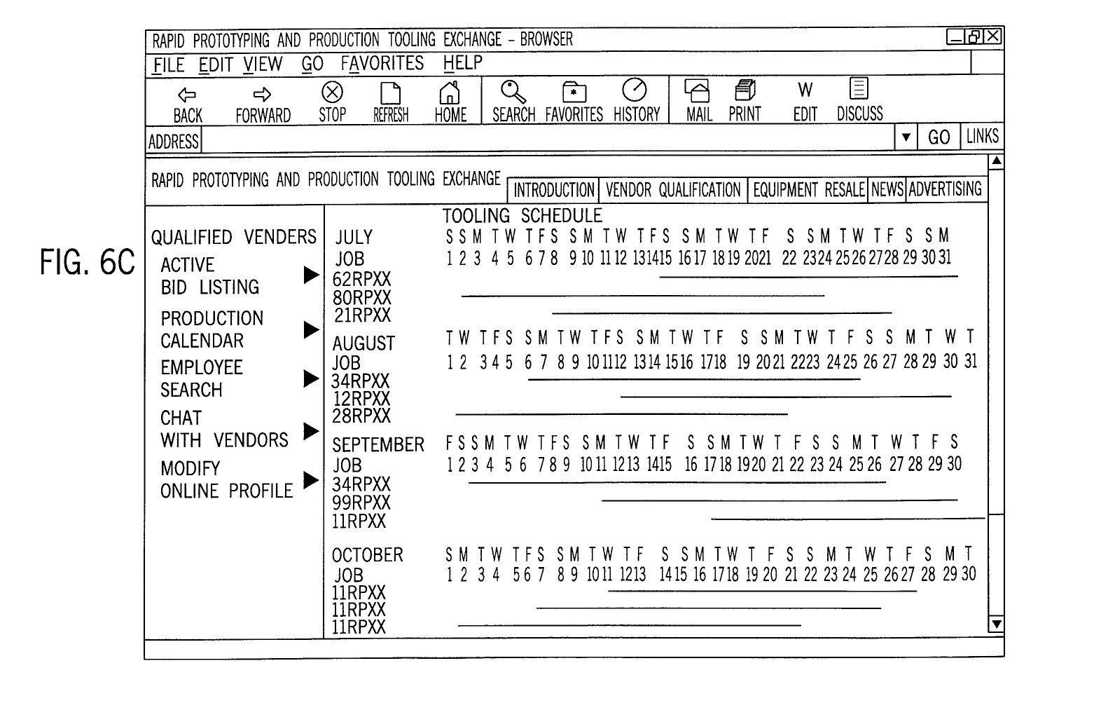

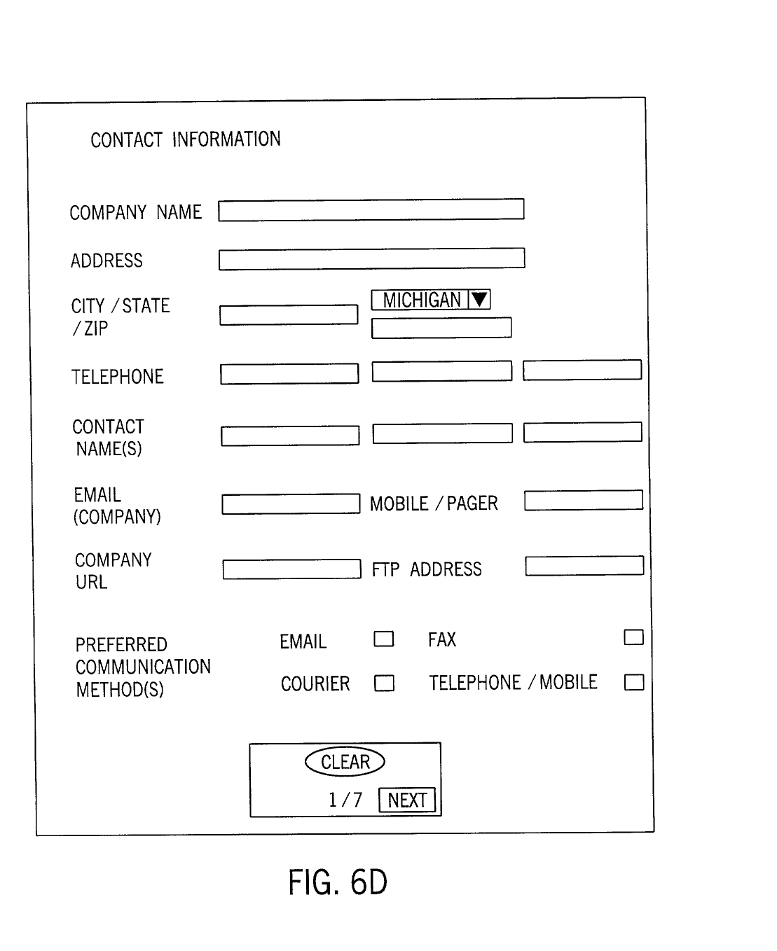

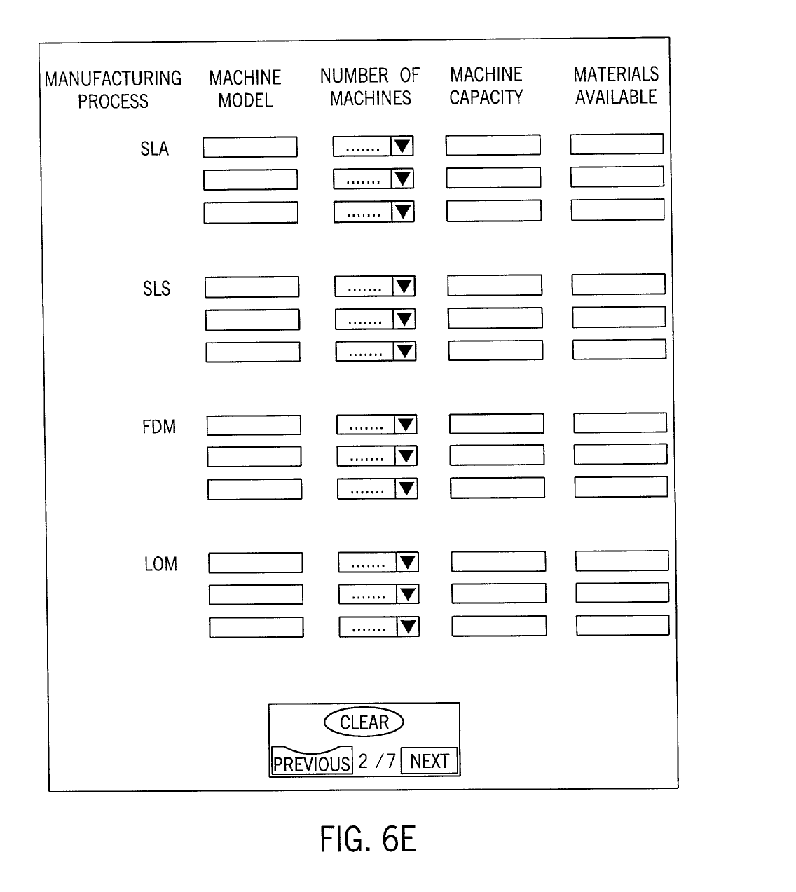

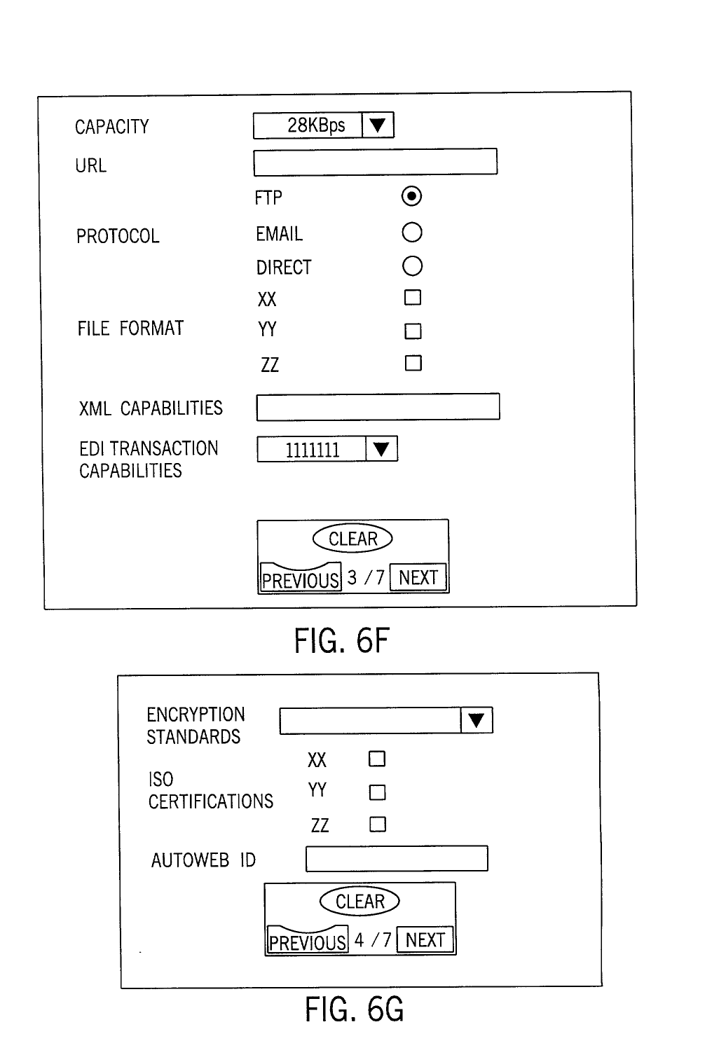

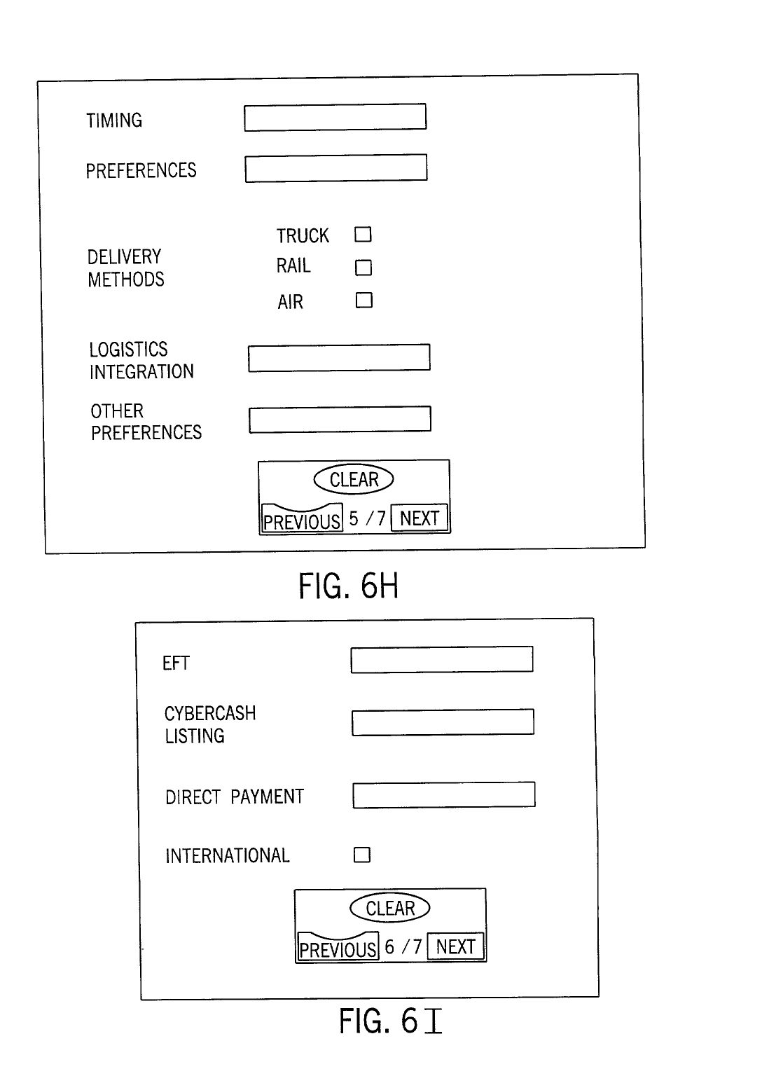

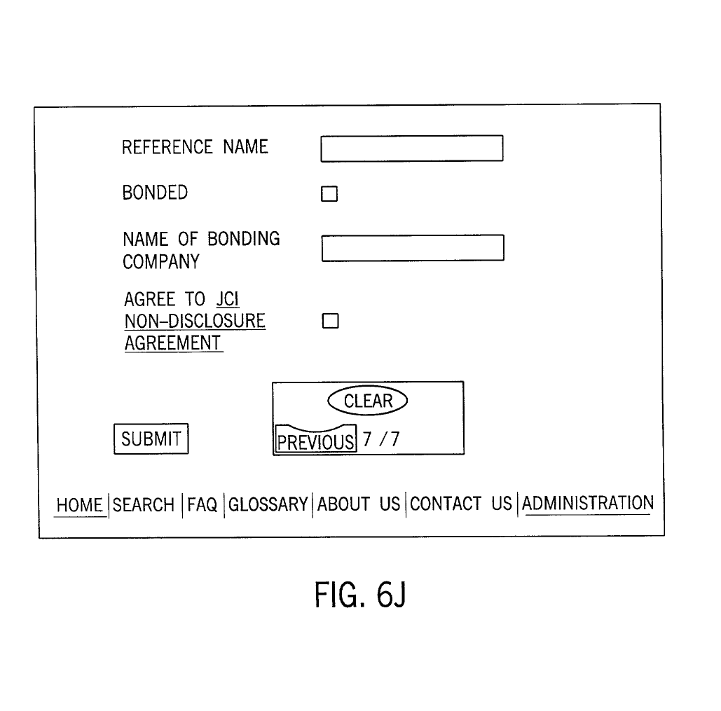

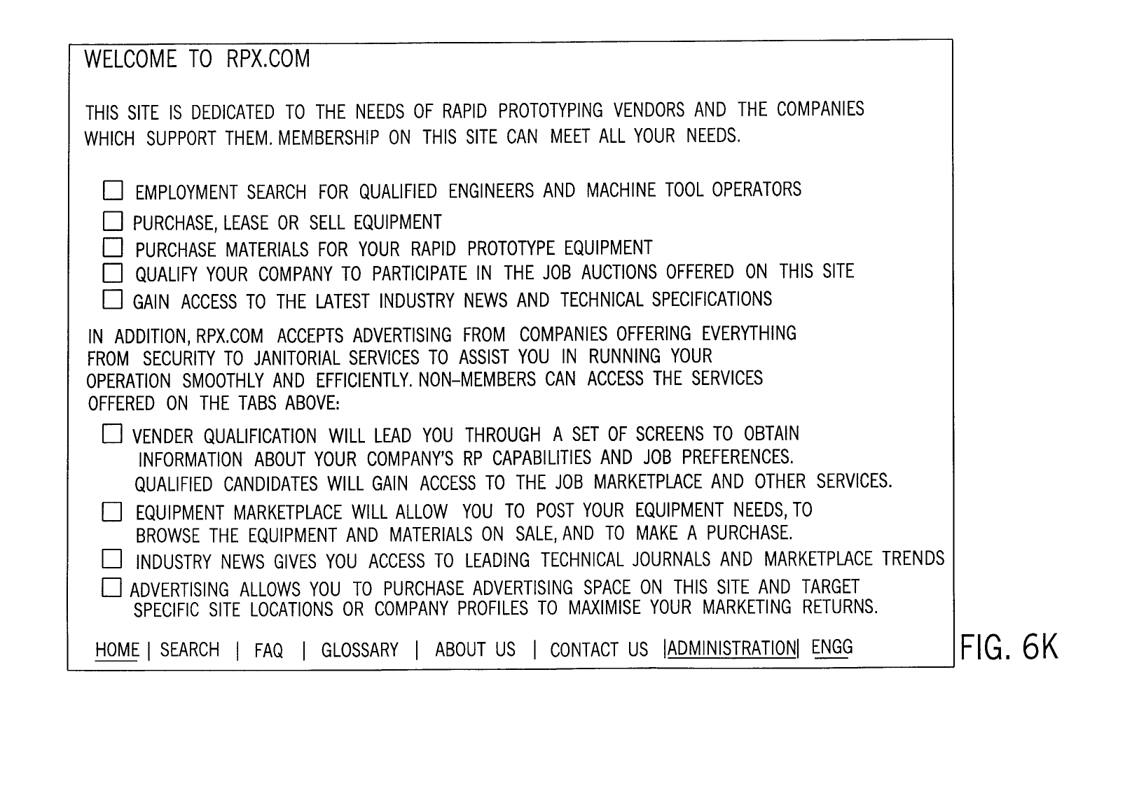

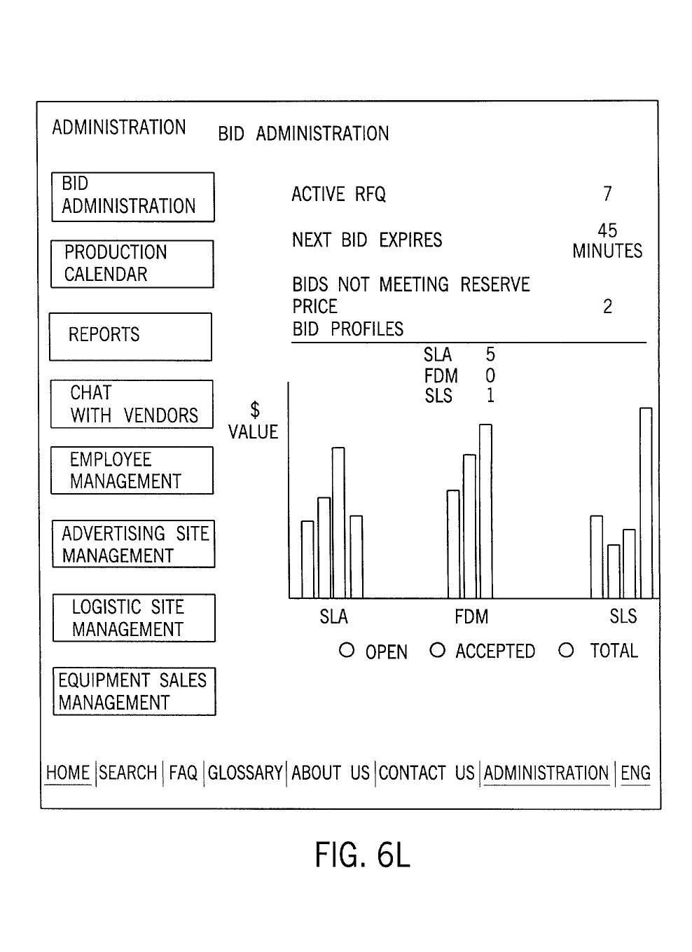

Referring now to FIG. 6, in an exemplary embodiment, a user interface 600 is depicted for an on-line rapid prototyping and production tooling exchange 610, or change management system. On-line rapid prototyping and production tooling exchange 610 includes a user interface 620 which is used for reaching qualified vendors with prototype and production tooling capabilities who are interested in bidding on specified production or production tooling tasks. On-line rapid prototyping and production tooling exchange 610 is dedicated to the needs of rapid prototyping and production tooling vendors and the companies which support them. Rapid prototyping and production tooling exchange 610 provides a plurality of functionalities, including an employee search, accessed by link 621, which searches for qualified engineers and machine tool operators that may be hired and equipment resale link 622 which functions to provide access to an environment for the purchase, lease, or sale of equipment.

Rapid prototyping and production tooling exchange 610 also includes a vendor qualification environment 623 which links to an environment for qualifying a company to participate in the job auctions offered on the site, for example to participate in bidding on specified jobs, for example, the jobs listed in display area 624, showing specified jobs, processes, details, a bid ending date, a delivery date, the number of parts to be delivered, a reserve price, and a current bid price or any other applicable categories. Further, system 610 allows users access to the latest news through link 624 and advertising through a link 625.

In an exemplary embodiment, a user who is interested in bidding on a specific job may go to that job listing and see the active bid listing screen 624. Active bid listing 624 may display a part or product to be tooled in display 628, and enlarged in FIG. 6A. A potential bidder may view the part in display 628 and submit a bid for the part by following link 629. Further, the part may be viewed in more detail by following link 630 or downloaded by following link 631, for further cost analysis before bidding. A link 632 allows real-time interaction between vendors and overall program management. As depicted in FIG. 6B, a vendor qualification routine may be used to collect data about each vendor before qualifying a vendor for bidding. For example, a link 640 allows a vendor to input contact information, a link 642 allows a vendor to indicate manufacturing capabilities, a link 644 allows a vendor to indicate network capabilities, a link 646 allows a vendor to input security standards, a link 648 allows a vendor to complete a job profile, a link 650 allows a vendor to indicate preferred payment options and a link 652 allows a vendor to provide references. One of the major advantages of rapid prototyping and production tooling exchange 610 is that it changes the procurer from sustaining a cost for the procurement of prototypes to providing a value by receiving bids from the most qualified or from the most cost effective vendors.

Further, in an exemplary embodiment, a link 654 provides a production calendar as depicted in FIG. 6C. FIG. 6C provides a tooling schedule indicating the jobs, and the precise tooling calendar. Accordingly, a potential vendor may be able to view the tooling schedule to determine whether tooling may be provided within the tooling schedule and base their bid accordingly. FIGS. 6D-6J depict exemplary display screens for the input of information, for example, contact information (FIG. 6D), manufacturing capabilities (FIG. 6E), network capabilities (FIG. 6F), security standards (FIG. 6G), job profile (FIG. 6H), payment options (FIG. 6I), and references (FIG. 6J). A link 660 links to an introduction screen or welcome screen, depicted in FIG. 6K. Further, in an exemplary embodiment, a bid administration screen may be utilized for displaying the bidding status, as depicted in FIG. 6L.

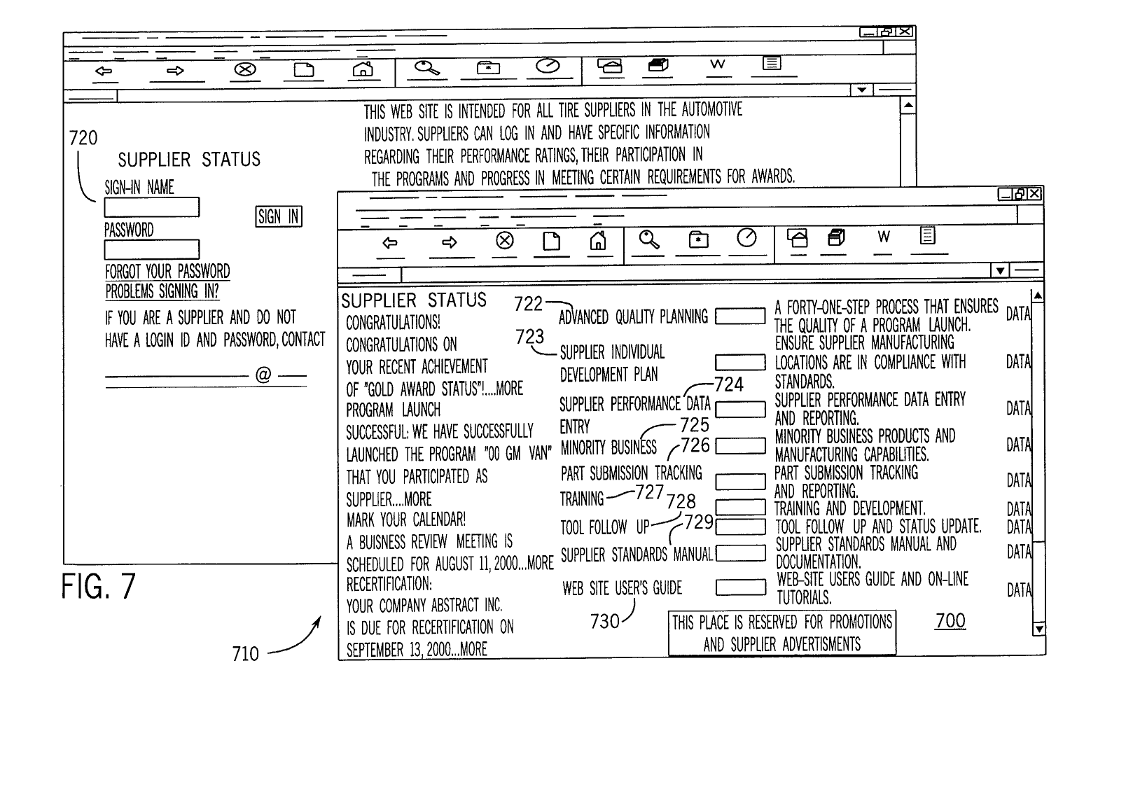

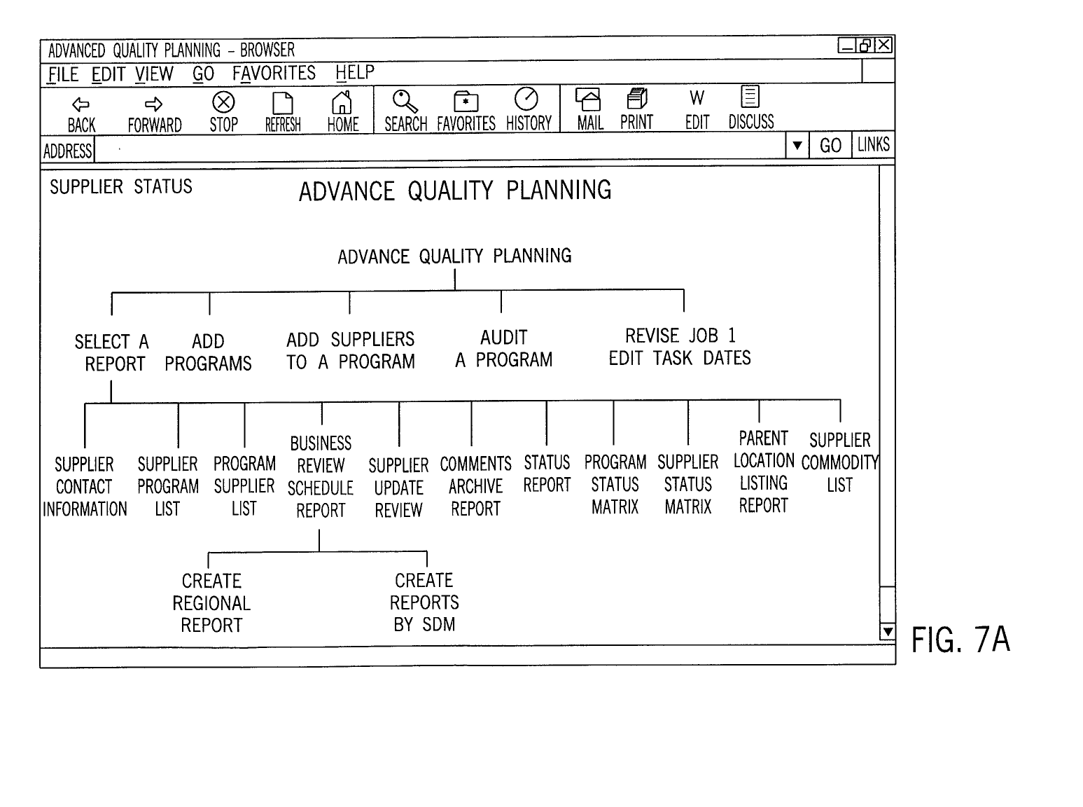

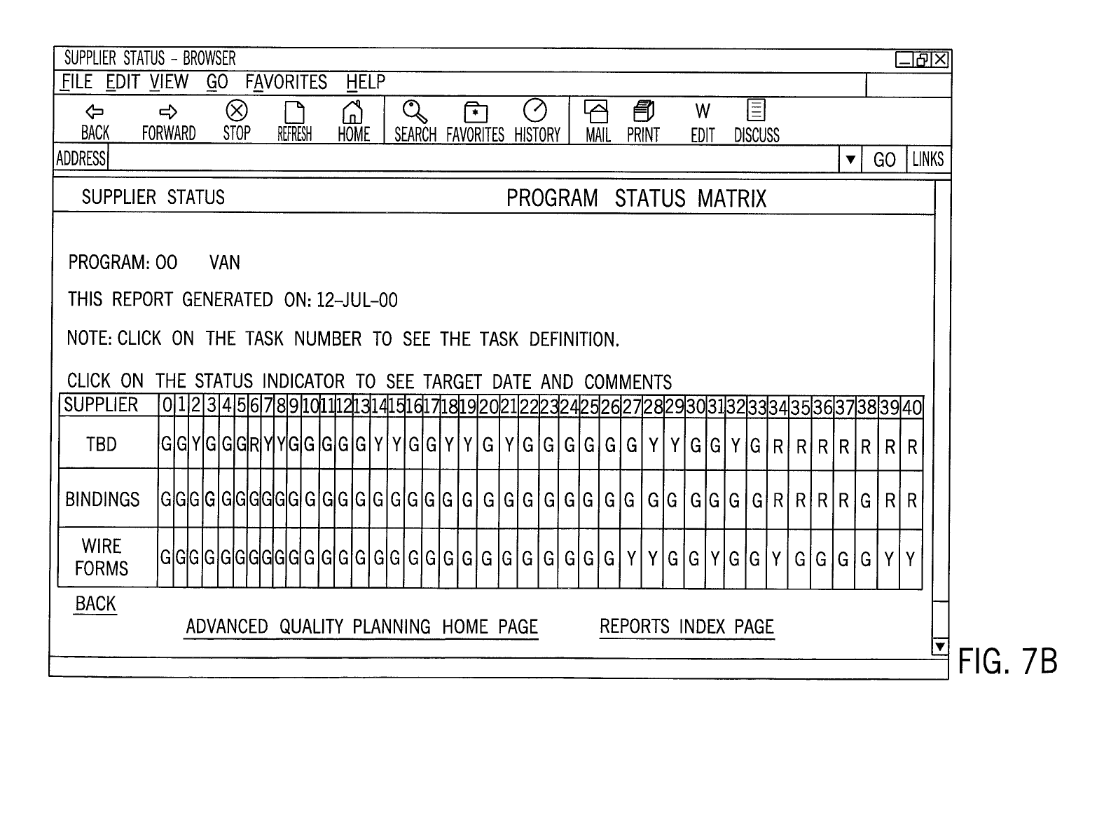

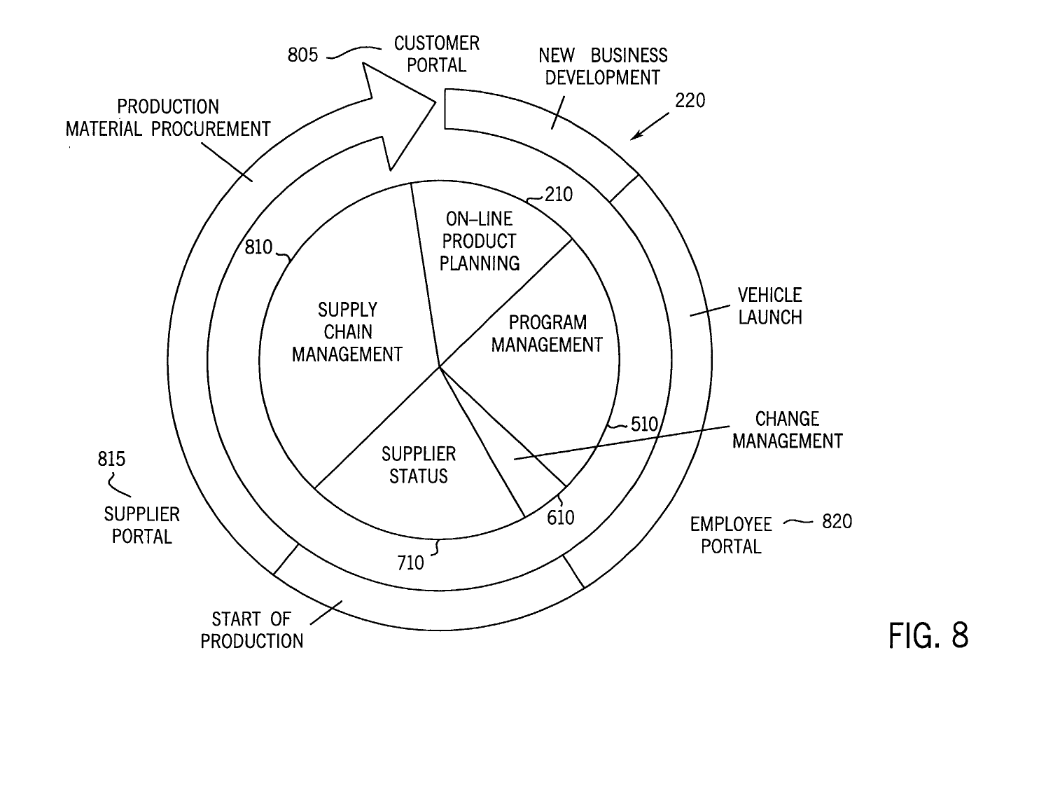

Referring now to FIG. 7, a user interface 700 for a supplier status system 710 is depicted for use by both internal and external suppliers. User interface 700 is a communications network interface in which a supplier may sign in using a sign-in name and password input in fields 720. The suppliers may log-in and have specific information regarding their performance ratings, their participation in specific programs, and progress in meeting certain requirements for awards, among other types of information. A supplier, who is logged in to the supplier status system, may view an advance quality planning screen through link 722. The advance quality planning routine is, in an exemplary embodiment, a multiple-step process that insures the quality launch of the product. The advance quality planning portion keeps the members of the program launch team, termed simultaneous development team, in communication with the suppliers and each other regarding a given program. The simultaneous development team may quickly review the advance quality planning for a given program and determine which suppliers are on target and which suppliers need more involvement with the team. The process also provides a forum for the simultaneous development team and suppliers to indicate concerns or foreseeable problems for a given program. Consistently using advance quality planning will lead to smoother, more timely launches. A first step in using the advance quality planning features is for the simultaneous development team to setup a template for their particular program. The program is initially defined by the name and job date in a standard timing pattern. These task dates may be adjusted with certain limitations by the simultaneous development team. Suppliers are then added to the program by the simultaneous development team. The suppliers are listed by parent corporation, as opposed to specific supplier location. A link 723 provides a user with a supplier individual development plan routine. The supplier individual development plan insures that supplier manufacturing locations are able to comply with all the standard requirements. The supplier individual development plan verifies competency in seven areas, in an exemplary embodiment, these areas are basic systems, program management capabilities, quality management systems, commercial systems, material systems, engineering systems, and leadership. The supplier individual development plan insures that supplier manufacturing locations are able to comply with all manufacturer requirements.

A link 724 refers a user to a supplier performance data entry routine. The supplier performance data entry and reporting measures the overall performance of a supplier. This includes the quality of parts shipped (measured in ppm), the accuracy of shipments, part submissions (ppap), time lines, and accuracy. Corrective actions, delivery ppm, mqr, pact, and 8D responsiveness. A quality and delivery date are entered monthly, for each supplier manufacturing location on a part by part basis. A manufacturer receiving plant personnel inputs the raw data for each supplier location shipping into the plan, rating both the quality of parts shipped and the accuracy of shipments in parts per million (ppm). Other data, such as cost reduction, technical expertise, and certification are entered by corporate purchasing. Reports are available for business units and regions. Manufacturer employees and suppliers can generate reports on the suppliers performance in a variety of ways including reports on individual supplier locations and reports which consolidate information from all locations of a particular supplier.

In an exemplary embodiment, a minority business link 725 leads a user to a page in which minority business enterprises become part of a manufacturer's supply base. Minority businesses can enter profiles, indicating their product offerings and manufacturing capabilities. A supplier or plant may list products they need. Any match between minority business offerings and plant or supplier needs automatically generates e-mail to the respective parties. This application helps connect minority business enterprises with plants and suppliers looking to add minority content. In an exemplary embodiment, there may be two minority business involvement programs, a procurement diversity program, which focuses on recruiting new minority business enterprises, and a minority supplier development program, which focuses on mentoring and development of minority suppliers. The intent of the procurement diversity program is to identify minority business enterprises which provide a competitive advantage (lower costs, strategically located facilities, engineering capability, etc.) that existing suppliers do not have. Non-production and indirect purchasing opportunities also are part of the companies minority business involvement programs. Under the minority supplier development program, assistance is available for minority product suppliers in obtaining key strategic supplier status and supply base. Key strategic suppliers are part of the extended enterprise and are eligible for training, quality systems development, cost reduction consulting, advanced product planning activities, and annual supplier awards.

Further, in an exemplary embodiment, a link 726 leads to a part submission tracking application. The part submission tracking application provides functionality to submit a new part or a part that is changed in design or specifications. The details are tracked throughout the life cycle of the approval process and manufacturing process. The ability to submit parts specifications on-line has the ability to speed up all the activities associated with the process. The information may be available to multiple people simultaneously. The review and approval process may be fast and accurate. The monitoring of the approval process may be easy and a timely action may be initiated immediately. The information may also be stored and retrieved by authorized users whenever it is required including in the production phase, if any problems are noticed with the part.

In an exemplary embodiment, a training and development link 727 may be included in the supplier status application. The training and development application allows users to access training material that is available on-line. Training material may be interactive and there may be a questionnaire at the end of the training module to gauge the understanding. Training material may include education for minority businesses on how to become and remain a product supplier to the manufacturer. In an exemplary embodiment, a tool follow-up link 728 may be included in supplier status application 710. The tool follow-up application helps track the tools used by the manufacturer internally and also tools use by tier II suppliers. By tracking these tools, there is provided an ability for controlling and reallocating the tools cost. Tool follow-up application 728 further helps in deciding where these costs belong, the OEMs, the overall manufacture, or the tier II suppliers. By closely monitoring the historical data, the ability to easily make strategic decisions about the tools and production responsibilities is enabled.

Supplier status application 710 may also include a supplier standards manual link 729. The supplier standard manual application is the authoritative resource that defines the manufacturer's expectations for its suppliers. It also defines responsibilities and relations with suppliers. In all cases, the on-line copy of the supplier standards manual will be assumed to be the correct and most up-to-date version; any paper copy of a manual has the disadvantage of being uncontrolled as soon as it is printed.

The purpose of the Supplier Standards Manual is to communicate requirements and expectations to suppliers. This provides a drive for excellence, in conjunction with a close working relationship and will enable both manufacturer and supplier to continuously improve and become leaders in a world class supply base. The Supplier Standards Manual may be an electronic file. Each supplier to the manufacturer is expected to have a Manufacturers Standards Manual champion which is required to periodically review the manual chapters and communicate changes within their organization. The manual may be updated on a regular basis timed with manufacturer meetings. All revisions that are addition to the Supplier Standards Manual will be reviewed and approved by the supplier development leadership board which may be comprised of regional supplier development leaders. The supplier development leadership board shall designate a section champion to coordinate in addition to propose changes to the review board. In an exemplary embodiment a web site users guide link 730 may be provided on supplier status application page 710. The purpose of the web site users guide is to provide the reader with an overview of the key features of the supplier status web site. The guide is intended for both manufacturer employees and suppliers to the manufacturer. The web site may be designed to prevent supplier's access to the specific information or permitting the manufacturer's employees wider access to information on all suppliers. Certain portions of the web site may not be available to non-manufacturer employees. To verify access, each user may be required to log in to the web site with a pre-assigned user name and password which identifies the user and determines what options he or she may access. FIG. 7A depicts a plurality of options available in the advanced quality planning application accessed through link 722. The advanced quality planning application includes selecting a report, adding programs, adding suppliers to a program, auditing a program, revising programs, editing task dates, the reports available in the selected report link are supplier contact information, supplier program list, program supplier list, business review scheduled report, supplier update review, comments archived report, status report, program status matrix, supplier status matrix, parent location listing report, supply or commodity listing, the business review schedule report includes creating a regional report and creating reports by SDM. In an exemplary embodiment, a program status matrix may be accessed, as depicted in FIG. 7B. Program status matrix shows supplier and task numbers, and provides status indicators, which may be linked to target dates and other status comments.

While the exemplary embodiments refer to terminals coupled to a central controller or central processor or centralized communications network, the invention may also be applied to internet browsing devices coupled to in communication with the internet or any other communications network. The exemplary embodiments may encompass those situations in which any electronic devices are coupled to and in communication with a communications network.

Further still, those who have skill in the art will recognize that the invention is applicable with many different hardware configurations, software architectures, communications protocols, and organizations or processes.

While the detailed drawings, specific examples, and particular formulations given describe exemplary embodiments, they serve the purpose of illustration only. Materials and configurations shown and described may differ depending on the chosen performance characteristics and physical characteristics of the communications network. For example, the type of communications network or communication protocols used may differ. The systems shown and described are not limited to the precise details and conditions disclosed. Furthermore, other substitutions, modifications, changes, and omissions may be made in the design, operating conditions, information exchange, and arrangement of the exemplary embodiments of software and user interfaces, without departing from the scope of the invention that is expressed above.

What is claimed is:

1. A product planning system accessible by a plurality of users, comprising:
a communications network;
a server computer in communication with the communications network;
a client computer in communication with the communications network;
a first program running on the server computer, the first program configured to provide access to a product planning environment through the client computer, the product planning environment having fields for entry of a target price and having fields for displaying a calculated price, the calculated price being based on selections of product characteristics and part selections being made by a user of the first program, the first program further providing a display of the product as configured by the user; and
a second program in communication with the first program, the second program using data from the first program and configured to provide product program management functions.

2. The product planning system of claim 1, wherein the display includes a graphical depiction of the product.

3. The product planning system of claim 1, wherein the display includes a textual description of the product.

4. The product planning system of claim 1, wherein the product planning environment includes a display field for entry of a price variance.

5. The product planning system of claim 1, wherein the communications network includes the internet.

6. The product planning system of claim 1, wherein a plurality of users at a plurality of client computers may access the product planning environment.

7. The product planning system of claim 1, wherein the first program provides a carryover opportunities display field.

8. The product planning system of claim 1, further comprising:
a third program in communication with the first or second program and providing supplier status information.

9. The product planning system of claim 1, further comprising:
a third program in communication with the first or second program and providing access to a rapid prototyping and production tooling system.

10. An automotive interior product planning system accessible by a plurality of users, comprising:
a communications network;
a server computer in communication with the communications network;
a client computer in communication with the communications network;
a first program running on the server computer, the first program configured to provide access to an automotive interior product planning environment through the client computer, the automotive interior product planning environment having fields for entry of a target price and having fields for displaying a calculated price, the calculated price being based on selections of product characteristics and part selections being made by a user of the first program, the first program further providing a display of the product as configured by the user; and
a second program in communication with the first program, the second program using data from the first program and configured to provide product program management functions.

11. The product planning system of claim 8, wherein the display includes a graphical depiction of the automotive interior product.

12. The product planning system of claim 8, wherein the display includes a textual description of the automotive interior product.

13. The product planning system of claim 8, wherein the product planning environment includes a display field for entry of a price variance.

14. The product planning system of claim 8, wherein the communications network includes the internet.

15. The product planning system of claim 8, wherein a plurality of users at a plurality of client computers may access the product planning environment.

16. The product planning system of claim 8, wherein the first program provides a carryover opportunities display field.

17. A method of planning an automotive interior product, comprising:
receiving from a user of a client computer a product characteristic input;
providing to the client computer data that may be used to configure a display of the product including the product characteristic input;
providing to the client computer price information relating to the product characteristic;
calculating a total price including a price related to the product characteristic; and
providing access to a product program management tool.

18. The method of claim 17, further comprising:
providing to the client computer data relating to carryover opportunities.

19. A product development system, comprising:
a communications network;
a server computer coupled to the communications network;
a client computer coupled to the communications network;
a program running on the server computer, the program configured with a product planning tool, and a program management tool.

20. The system of claim 19, further comprising:
a supplier status system.

21. The system of claim 1 9, further comprising:
a rapid prototyping and production tooling system.

22. The system of claim 20, wherein the supplier status system includes a supplier progress indicator.

23. The system of claim 20, wherein the supplier status system includes a performance rating indicator.

24. The system of claim 21, wherein the rapid prototyping system includes a bidding system.

25. The system of claim 21, wherein the rapid prototyping and production tooling system includes a vendor qualifying routine.
